(19) United States
(12) Patent Application Publication
(10) Pub. No.: US 2026/0337474 A1
(43) Pub. Date: Oct. 29, 2026

(54) GEOPOLYMER COMPOSITIONS AND METHODS

(71) Applicant: SCHLUMBERGER TECHNOLOGY CORPORATION, Sugar Land, TX (US)

(72) Inventors: Bipin JAIN, Richmond, TX (US); Shameed ASHRAF, Kuala Lumpur (MY)

(21) Appl. No.: 18/997,387

(22) PCT Filed: Jul. 21, 2023
(86) PCT No.: PCT/US2023/070739

§ 371 Date: Jan. 21, 2025

Related U.S. Application Data
(60) Provisional application No. 63/369,025, filed on Jul. 21, 2022.

(51) Int. Cl. C09K 8/473; C04B 12/00; C04B 14/30; C04B 28/00

(52) U.S. Cl. CPC C09K 8/473; C04B 12/005; C04B 14/304; C04B 28/006

(57) ABSTRACT

Geopolymer precursors are presented that are useful for subterranean wells. The precursors contain an aluminosilicate source, an alkali activator, and a carrier fluid. Additives are incorporated into the precursors to induce expansion, self-healing, flexibility, and to improve tensile and shear-bond strength.

### CROSS REFERENCE TO RELATED APPLICATION

This patent application claims benefit of U.S. Provisional Patent Application Ser. No. 63/369,025 filed Jul. 21, 2022, which is entirely incorporated herein by reference. The present disclosure broadly relates to well cementing. More particularly the invention relates to the use of geopolymers, to geopolymer slurry compositions and the related methods of placing the geopolymer composition in a well using conventional or unconventional cementing techniques.

### BACKGROUND

Geopolymers are a class of materials that are formed by chemical dissolution and subsequent recondensation of various aluminosilicate oxides and silicates to form an amorphous three-dimensional framework structure. Therefore, a geopolymer is a three-dimensional aluminosilicate mineral polymer. The term geopolymer was proposed and first used by J. Davidovits (Synthesis of new high-temperature geo-polymers for reinforced plastics/composites, SPE PACTEC' 79, Society of Plastics Engineers) in 1976 at the IUPAC International Symposium on Macromolecules held in Stockholm.

Geopolymers based on aluminosilicates are designated as poly(sialate), which is an abbreviation for poly(silicon-oxo-aluminate) or (—Si—O—Al—O—)ₙ (with n being the degree of polymerization). The sialate network comprises SiO₄ and AlO₄ tetrahedra linked alternately by sharing all the oxygen atoms, with Al³⁺ and Si⁴⁺ in IV-fold coordination with oxygen. Positive ions (Na⁺, K⁺, Li⁺, Ca²⁺ . . . ) may be present in the framework cavities to balance the negative charge of Al³⁺ in IV-fold coordination.

The empirical formula of polysialates is: Mₙ {—(SiO₂)_{z}—AlO₂}ₙ, w H₂O, wherein M is a cation such as potassium, sodium or calcium, n is a degree of polymerization and z is the Si/Al atomic ratio that may be 1, 2, 3 or more.

The three-dimensional (3D) geopolymers networks are summarized in Table 1.

TABLE 1
Geopolymer chemical designations (wherein M is a cation such
as K, Na or Ca, and n is a degree of polymerization).

| Si/Al | | | |
|---|---|---|---|
| ratio | Designation | Structure | Abbreviations |
| 1 | Poly(sialate) | Mₙ(—Si—O—Al—O—)ₙ | (M)-PS |
| 2 | Poly(sialate-siloxo) | Mₙ(—Si—O—Al—O—Si—O)ₙ | (M)-PSS |
| 3 | Poly(sialate-disiloxo) | Mₙ(—Si—O—Al—O—Si—O—Si—O—)ₙ | (M)-PSDS |

The properties and application fields of geopolymers depend principally on their chemical structure, and more particularly on the Si/Al molar ratio. Geopolymers have been investigated for use in several applications, including as concrete systems within the construction industry, as refractory materials and as encapsulants for hazardous and radioactive waste streams. Geopolymers are also recognized as being rapid setting and hardening materials. They exhibit superior hardness and chemical stability.

Geopolymer compositions have been applied in the construction industry. In particular, U.S. Pat. No. 4,509,985 discloses a mineral polymer composition employed for fabricating cast or molded products at room temperature, or temperatures generally up to 120 °C. U.S. Pat. Nos. 4,859,367, 5,349,118 and 5,539,140 disclose a geopolymer for solidifying and storing hazardous waste materials in order to provide the waste materials with a high stability over a very long time, comparable to certain archeological materials. U.S. Pat. Nos. 5,356,579, 5,788,762, 5,626,665, 5,635,292 U.S. Pat. Nos. 5,637,412 and 5,788,762 disclose cementitious systems with enhanced compressive strengths or low density for construction applications. Patent application WO 2005019130 highlights the problem of controlling the setting time of a geopolymer system in the construction industry.

A well-known practice in oil, gas, or other wells, which have a borehole penetrating a number of earth formations, is to cement a steel casing in place within the bore by placing cement slurry between the steel casing and the borehole walls. Traditionally, hydratable cements such as portland cement have been employed in well cementing. More recently, as discussed in U.S. Pat. No. 7,794,537, geopolymer systems have been developed for this purpose. However, the current disclosure is nevertheless further envisioned to encompass additional applications including mining construction, tunneling, cable laying and grouting.

In subterranean wells, geopolymer compositions may be subjected to elevated temperatures, as well as mechanical stresses that may not exist in applications that take place at the surface. For example, temperatures may fluctuate, resulting in expansion or contraction of tubular bodies and/or formation structures to which the geopolymer composition is bonded, possibly resulting in debonding. Well activities that take place after the geopolymer composition has set may also cause the formation of cracks in the geopolymer matrix or debonding of the geopolymer composition with tubular bodies and/or formation structures. Such activities may include further drilling that introduces vibrations of the cement sheath and tubular bodies. Or, hydraulic fracturing operations may exert elevated pressures inside the tubular bodies that may cause tubular body expansion and disruption of the geopolymer sheath. Geopolymer systems are needed that withstand the aforementioned stresses while maintaining their integrity and bonding to tubular body and formation surfaces.

### SUMMARY

Embodiments described herein provide a method, comprising forming a geopolymer precursor comprising an aluminosilicate source, a metal silicate, a dispersed expanding agent, an alkali activator and a carrier fluid; placing the geopolymer precursor into a subterranean well; and causing the geopolymer precursor to harden and set within the subterranean well to form a geopolymer.

Other embodiments described herein provide a method, comprising forming a geopolymer precursor comprising an aluminosilicate source, a dispersed expanding agent, an alkali activator, and a carrier fluid; placing the geopolymer precursor at a target location; and causing the geopolymer precursor to harden and set at the target location to form a geopolymer.

Other embodiments described herein provide a method, comprising forming a pumpable geopolymer base comprising an aluminosilicate source, a metal silicate, and an alkali activator and a carrier fluid; dispersing an expanding agent within the geopolymer base to form a geopolymer precursor; placing the geopolymer precursor into a subterranean well; and causing the geopolymer precursor to harden and set within the subterranean well to form a geopolymer.

Other embodiments described herein provide a method, comprising forming a pumpable geopolymer base comprising an aluminosilicate source, and an alkali activator and a carrier fluid; dispersing an expanding agent within the geopolymer base to form a geopolymer precursor; placing the geopolymer precursor at a target location; and causing the geopolymer precursor to harden and set at the target location to form a geopolymer.

Other embodiments described herein provide a method, comprising forming a geopolymer precursor comprising an aluminosilicate source; a metal silicate; a self-healing agent; an alkali activator; one or more of an expanding agent, a flexibility agent, and a tensile strength improvement agent; and a carrier fluid; placing the geopolymer precursor into a subterranean well; and causing the geopolymer precursor to harden and set within the subterranean well to form a geopolymer.

Other embodiments described herein provide a method, comprising forming a geopolymer precursor comprising an aluminosilicate source; a self-healing agent; an alkali activator; one or more of an expanding agent, a flexibility agent, and a tensile strength improvement agent; and a carrier fluid; placing the geopolymer precursor at a target location; and causing the geopolymer precursor to harden and set at the target location to form a geopolymer.

Other embodiments described herein provide a method, comprising forming a pumpable geopolymer base comprising an aluminosilicate source, a metal silicate, and an alkali activator and a carrier fluid; dispersing a self-healing agent and one or more of an expanding agent, a flexibility agent, and a tensile strength improvement agent within the geopolymer base to form a geopolymer precursor; placing the geopolymer precursor into a subterranean well; and causing the geopolymer precursor to harden and set within the subterranean well form a geopolymer.

Other embodiments described herein provide a method, comprising preparing a pumpable geopolymer base comprising an aluminosilicate source, an alkali activator and a carrier fluid; dispersing a self-healing agent and one or more of an expanding agent, a flexibility agent, and a tensile strength improvement agent within the geopolymer base to form a geopolymer precursor; placing the geopolymer precursor at a target location; and causing the geopolymer precursor to harden and set at the target location to form a geopolymer.

Other embodiments described herein provide a method, comprising forming a geopolymer precursor comprising an aluminosilicate source, a metal silicate, a flexibility agent, an alkali activator and a carrier fluid; placing the geopolymer precursor into a subterranean well; and causing the geopolymer precursor to harden and set within the subterranean well to form a geopolymer.

Other embodiments described herein provide a method, comprising forming a geopolymer precursor comprising an aluminosilicate source, a flexibility agent, an alkali activator and a carrier fluid; placing the geopolymer precursor at a target location; and causing the geopolymer precursor to harden and set within the subterranean well to form a geopolymer.

Other embodiments described herein provide a method, comprising forming a pumpable geopolymer base comprising an aluminosilicate source, a metal silicate, and an alkali activator and a carrier fluid; dispersing a flexibility agent within the geopolymer base to form a geopolymer precursor; placing the geopolymer precursor into a subterranean well; and causing the geopolymer precursor to harden and set within the subterranean well form a geopolymer.

Other embodiments described herein provide a method, comprising forming a pumpable geopolymer base comprising an aluminosilicate source, and an alkali activator and a carrier fluid; dispersing a flexibility agent within the geopolymer base to form a geopolymer precursor; placing the geopolymer precursor at a target location; and causing the geopolymer precursor to harden and set at the target location to form a geopolymer.

Other embodiments described herein provide a method, comprising forming a geopolymer precursor comprising an aluminosilicate source, a metal silicate, a fiber material, an alkali activator and a carrier fluid; placing the geopolymer precursor into a subterranean well; and causing the geopolymer precursor to harden and set within the subterranean well to form a geopolymer.

Other embodiments described herein provide a method, comprising forming a geopolymer precursor comprising an aluminosilicate source, a fiber material, an alkali activator and a carrier fluid; placing the geopolymer precursor at a target location; and causing the geopolymer precursor to harden and set at the target location to form a geopolymer.

Other embodiments described herein provide a method, comprising forming a pumpable geopolymer base comprising an aluminosilicate source, a metal silicate, an alkali activator and a carrier fluid; dispersing a fiber material within the geopolymer base to form a geopolymer precursor; placing the geopolymer precursor into a subterranean well; and causing the composition to harden and set within the subterranean well to form a geopolymer.

Other embodiments described herein provide a method, comprising preparing a pumpable geopolymer base comprising an aluminosilicate source, and an alkali activator and a carrier fluid; dispersing a fiber material within the geopolymer base to form a geopolymer precursor; placing the geopolymer precursor at a target location; and causing the geopolymer precursor to harden and set at the target location to form a geopolymer.

Other embodiments described herein provide a geopolymer precursor comprising an aluminosilicate source; an alkali activator, a carrier fluid, and at least two additives selected from the group consisting of a self-healing agent, an expanding agent, a flexible agent, and a tensile strength improvement agent.

### BRIEF DESCRIPTION OF THE DRAWINGS

FIG. 1 shows the self-healing behavior of geopolymer formulations exposed to a hydrocarbon oil.

FIG. 2 shows the self-healing behavior of geopolymer formulations exposed to carbon dioxide.

FIG. 3 shows the expansion behavior of geopolymer formulations containing a CaO/MgO blend in powder or slurry form.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term about should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific, it is to be understood that inventors appreciate and understand that any data points within the range are to be considered to have been specified, and that inventors possessed knowledge of the entire range and the points within the range.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

The geopolymer formulations described herein involve the use of an aluminosilicate source and an alkali activator in a carrier fluid at near-ambient temperature. The carrier fluid may be aqueous or non-aqueous. As it has been said previously, all three components do not need necessarily to be added separately; for example, the alkali activator can be added as a water solution. So, the aluminosilicate source can be in the form of a solid component and the alkali activator can be in the form of a solid or of an aqueous solution of alkali activator.

Formation of the set geopolymer involves an aluminosilicate source, which is also called aluminosilicate binder. Examples of aluminosilicate sources from which geopolymers may be formed include (but are not limited to) ASTM type C fly ash, ASTM type F fly ash, ground blast furnace slag, calcined clays, partially calcined clays (such as metakaolin), aluminum-containing silica fume, natural aluminosilicate, synthetic aluminosilicate glass powder, zeolite, scoria, allophone, bentonite, red mud, calcined red mud and pumice. These materials contain a significant proportion of an amorphous aluminosilicate phase, which reacts in strong alkaline solutions. The more common aluminosilicates are fly ash, metakaolin and blast furnace slag. Mixtures of two or more aluminosilicate sources may also be used if desired. In addition, alumina and silica may be added separately, for example as a blend of bauxite and silica fume. In another embodiment, the aluminosilicate component comprises a first aluminosilicate binder and optionally one or more secondary binder components which may include ground granulated blast furnace slag, portland cement, kaolin, metakaolin or silica fume.

Formation of the set geopolymer also involves an alkali activator. The alkali activator may be an alkali metal, an alkaline-earth metal hydroxide, or combinations thereof. Alkali metal hydroxides may be sodium or potassium hydroxide. Alkaline-earth metal hydroxides may include calcium or barium hydroxide. The metal hydroxide may be in the form of a solid or an aqueous mixture. Also, the activator in another embodiment can be encapsulated. The activator when in solid and/or liquid state can be trapped in a capsule that will break when subjected to, for example, mechanical stress on the capsule, or coating degradation owing to temperature, chemical exposure or radiation exposure. Also, the activator when in solid and/or liquid state can be trapped in a capsule that will naturally degrade if made from a biodegradable or self-destructive material. Furthermore, the alkali activator when in liquid state may be adsorbed into a porous material and may be released after a certain time or due to a predefined event. The alkali activator may be present in the composition at a concentration between about 1M to 10M or between 3M and 6M.

Formation of a geopolymer may also involve a metal silicate. The metal silicate may be an alkali metal silicate such as sodium silicate, sodium metasilicate or potassium silicate. The sodium metasilicate may be present at a concentration between 0.02 kg/L and 0.2 kg/L, or between 0.05 kg/L and 0.1 kg/L. The SiO₂/Na₂O molar ratio may be less than or equal to 3.2. The SiO₂/K₂O molar ratio may be less than or equal to or less than 3.2. The metal silicate may be present in the composition at a concentration between about 0.1M and 5M, or between 0.5M and 2M. The metal silicates may be dry blended with the aluminosilicate source. Also, the metal silicate in another embodiment may be encapsulated.

The methods presented herein are applicable to the oilfield, for example during completion of the wellbore of oil or gas wells. To be used in oilfield applications, a pumpable precursor is formed where the geopolymer precursor is provided with a carrier fluid. Various additives may be added to the precursor, and the precursor may then be pumped into the wellbore. Pumpability may be defined as a slurry consistency lower than about 70 Bc as measured by a high-temperature, high-pressure rotational viscometer. The yield value (Ty) may be lower than about 60 lbf/100 ft². The precursor is then caused, or allowed, to set and harden in the well to provide zonal isolation in the wellbore. In other contexts, a geopolymer precursor can be prepared, placed at a target location, by pumping or any other suitable means, and caused, or allowed, to set and harden to provide the advantages of a geopolymer in any suitable application.

The technology described herein relates to methods for obtaining improved mechanical strength, imparting self-healing, imparting flexibility, and providing expansion properties in a geopolymer system. Such improved properties may help overcome various performance issues with cementitious materials described above. The additives described herein for imparting such features can be dispersed within a geopolymer base, which itself may be pumpable, to form a geopolymer precursor. The geopolymer base may comprise an aluminosilicate source and an alkali activator in a carrier fluid, optionally with a metal silicate source. Alternately, the ingredients of the geopolymer precursor, including the additives described herein, can be added to the carrier fluid in no particular order. The additives described herein can be provided to the geopolymer precursor as a slurry, so forming the geopolymer precursor can include adding a slurry of one or more of the additives described herein in a hydrocarbon oil, an aqueous fluid, a glycol fluid, or a combination thereof.

The geopolymer precursors described herein may have a multimodal particle-size distribution.

### Expanding Geopolymer Systems

Geopolymer systems, for example surrounding a steel casing in a well, may experience a shrinkage upon setting, resulting in a poor mechanical bond between the geopolymer and other components, such as the casing and the borehole wall. Such situations may allow undesirable fluid (which term includes liquids and gases) communication, for example between different formation zones penetrated by the bore of a well, or even allowing fluids produced from certain zones of a well to undesirably leak to the surface. Such situations may be exacerbated for example, when temperature or pressure variations cause dimensional perturbations in the bonded components. In general, volume or shape change of a geopolymer object upon setting may be unwanted.

In a subterranean well setting, zonal isolation may be preserved by incorporating an expanding agent into the geopolymer precursor. Volume and shape changes generally can be reduced, managed, minimized, or in some cases eliminated by incorporating expanding agents. Such expanding agents are active after the geopolymer precursor has set and hardened into a geopolymer sheath surrounding the casing. The expanding agent may comprise, or may be, calcium oxide, magnesium oxide, calcium sulphoaluminate, gypsum, finely ground aluminum powder, or a combination thereof. Both of these oxides hydrate to form hydroxides that have a lower specific gravity than their respective oxides. As a result, upon hydration, a bulk expansion may take place that in turn causes the geopolymer sheath to expand. Imperfections within the set geopolymer sheath may be healed, and shear-bond strength between the geopolymer sheath and the formation may be improved.

The expanding agent may be present in the geopolymer precursor at a concentration between 1% and 30% by weight of solids, or between 2% and 10% by weight of solids. The expanding agent particles may comprise particles having an average particle size between 0.1 μm and 900 μm, or between 0.2 μm and 250 μm. The expanding agent particles may be post-added to the geopolymer precursor as a slurry comprising a hydrocarbon oil, a glycol fluid, or both. The glycol may be ethylene glycol. The slurry medium is generally selected to avoid significant pre-expansion of the expanding agent, but the slurry medium can include a quantity of a fluid that will cause the expanding agent to pre-expand somewhat. Post addition comprises preparing the pumpable geopolymer precursor without the expanding agent; then, at a later time, adding the expanding agent slurry to the geopolymer precursor. The slurry may be added as the geopolymer precursor is being placed in the subterranean well.

After the geopolymer precursor sets, the linear expansion of the geopolymer sheath may be between 0.1% and 5.0%, or between 0.2% and 3.0%.

To prevent premature hydration of the expanding agent, the expanding agent may be calcined at temperatures between 100 °C and 2000 °C, or between 500 °C and 1500 °C. This may cause the formation of a hard shell that is resistant to hydration at ambient temperatures. Thus, each particle of an expanding agent can have a hardened exterior surface to resist and delay hydration.

Further delay of hydration may be accomplished by encapsulating the expanding agent particles with a coating that may degrade or rupture. The degradation mechanism may comprise dissolution or melting triggered at a specific temperature. Rupture may be initiated by external or internal pressure. Internal pressure may be initiated by having a coating that is slightly permeable. As water infiltrates and the expanding agent hydrates within the coating shell, the resulting expansion may cause the shell to crack and allow full hydration of the expanding agent. An example of an encapsulated expanding agent may be found in U.S. Pat. No. 10,526,523. The expanding agent can be used in liquid form by suspending the expanding agent in a non-aqueous fluid, which may be viscosified.

### Self-Healing Geopolymer Systems

Self-healing geopolymers are those which may contain additives that react and/or swell upon contact with downhole fluids, or fluids in other settings that activate self-healing. In a subterranean well context, when deterioration occurs, exposing the geopolymer or a surface thereof to the downhole fluids, the additives respond and seal cracks or fissures, thereby restoring geopolymer integrity and well zonal isolation. The downhole fluids may comprise liquid or gaseous hydrocarbons, aqueous fluids such as brines, carbon dioxide, nitrogen, helium, or combinations thereof. Carbon dioxide, nitrogen, and helium may be naturally occurring in reservoir fluids, or injected into the well from the surface. The self-healing agents may be designed to selectively swell upon contact with one or more of these fluids. In other settings, such fluids can be used to activate self-healing of a geopolymer object.

As described earlier, the geopolymer sheath may be disturbed and compromised by temperature and pressure fluctuations arising from drilling, stimulation and production operations. Such disturbances may take place years after placement of the geopolymer sheath.

The self-healing agents may comprise thermoplastic block polymer particles, wherein the particles comprise styrene-butadiene-styrene (SBS) or styrene-isoprene-styrene (SIS) or both, either or both of which may be block copolymers. The self-healing agents may comprise poly-bicyclo[2.2.1]hept-2-ene (polynorbornene), alkylstyrene, vinyl acrylate copolymers, which may be crosslinked and/or substituted, and/or diatomaceous earth. The self-healing agents may comprise vulcanized rubber, ground rubber, and/or carbon black. Or, the self-healing agents may comprise an asphaltite mineral such as GILSONITE™. Combinations of the above materials can also be used to provide a self-healing agent responsive to a variety of materials.

The self-healing agents may be added in a form having any reasonable shape and/or size. The form may be spherical, fiber-like, ovoid, a mesh system, ribbon, or other shape that allows easy incorporation in geopolymer precursors that have solid materials in selected particle size bands. Mixing and pumping can be facilitated by using granular particles having dimension less than about 900 μm, for example less than about 850 μm.

The self-healing agents are added to a geopolymer precursor before the precursor is hardened into a geopolymer. The self-healing agent may be present in the geopolymer precursor at a concentration between about 1% and 75% by weight of solids in the geopolymer precursor, or between about 5% and 50% by weight of solids. The particle size of the self-healing agent may be between about 1 μm and 900 μm, or between about 5 μm and 500 μm. The self-healing agent may be provided in the form of a slurry comprising a hydrocarbon oil, an aqueous fluid, a glycol, or a combination thereof, where the fluidic medium of the slurry is generally selected to avoid pre-swelling the self-healing agents.

The geopolymer precursor may further comprise one or more of the following materials: an aqueous inverse emulsion of polymer comprising a betaine group, poly-2,2,1-bicyclo heptane (polynorbonene), alkylstyrene, crosslinked substituted vinyl acrylate copolymers, diatomaceous earth, natural rubber, polyisoprene rubber, vinyl acetate rubber, polychloroprene rubber, acrylonitrile butadiene rubber, hydrogenated acrylonitrile butadiene rubber, EPDM polymer, ethylene propylene rubber, styrene butadiene rubber, styrene/propylene/diene rubber, styrene/isoprene copolymer, brominated poly(isobutylene-co-4-methylstyrene), butyl rubber, chlorosulfonated polyethylenes, polyacrylate rubber, polyurethane, silicone rubber, brominated butyl rubber, chlorinated butyl rubber, chlorinated polyethylene, epichlorohydrin ethylene oxide copolymer, ethylene acrylate rubber, sulfonated polyethylene, fluoro silicone rubbers, fluoroelastomers, substituted styrene acrylate copolymers and bivalent cationic compounds. Any copolymer or multipolymer listed above may be a block polymer to any degree or a non-block (e.g. random) polymer.

### Flexible Geopolymer Systems

Today, the mechanical properties of cementitious materials are a topic of considerable interest. In addition to the traditional unconfined-compressive-strength measurement, tensile strength, Young's modulus and Poisson's ratio are frequently considered during the design process.

During the life of a well into which a geopolymer has been placed, for example, the set geopolymer can fail due to shear and compressional stresses. Such failures can happen in other contexts both below and above ground. There are several stress conditions associated with such failures. In a hydrocarbon well, one such condition is the result of relatively high fluid pressures and temperatures inside the casing during testing, perforating, hydraulic fracturing or fluid production. Another stress condition results from exceedingly high pressures that occur inside a geopolymer due to thermal expansion of interstitial fluids. A third condition involves movement of surrounding materials such as the formation into which a geopolymer is placed or on which a geopolymer object is supported. When such stresses are encountered, the set geopolymer can fail in the form of cracking of the geopolymer matrix, or by a breakdown of bonds between the geopolymer and other components. For example, in a well, the geopolymer can exhibit radial-circumferential cracking and bonding between geopolymer and casing or between geopolymer and formation can fail. Such failures may compromise zonal isolation and lead to severe well problems. Thus, the well cementing industry has recognized the need for highly resilient and flexible cementitious compositions that can withstand the stresses outlined above. Such capabilities are also sought in other industries. The risk of rupture may be directly linked to the tensile strength of the set geopolymer, and is attenuated when the ratio of tensile strength to Young's modulus is increased. Young's modulus characterizes the flexibility of a material. Thus, to increase the tensile strength/Young's modulus ratio, the set geopolymer may have a low Young's modulus. Consequently, geopolymer systems with reduced Young's moduli have been developed.

Precursors for such geopolymer systems comprise an aluminosilicate source, optionally a metal silicate, a flexibility agent, an alkali source, which can be an alkali or alkaline earth hydroxide source, and a carrier fluid. The flexibility agent is a material that reduces the Young's modulus of the hardened geopolymer. The flexibility agent may comprise ground vulcanized rubber, polypropylene copolymer, or acrylonitrile-butadiene rubber, or a combination thereof.

The flexibility agent may be present in the geopolymer precursor at a concentration between 1% and 75% by weight of solids, or between 5% and 50% by weight of solids. The flexibility agent may have a particle size between about 1 μm and 900 μm, or between 5 μm and 500 μm. The flexibility agent may be provided in the form of a slurry comprising a hydrocarbon oil, an aqueous fluid, a glycol fluid, or a combination thereof.

The geopolymer precursor may further comprise one or more of the following materials: an aqueous inverse emulsion of polymer comprising a betaine group, poly-2,2,1-bicyclo heptane (polynorbonene), alkylstyrene, crosslinked substituted vinyl acrylate copolymers, diatomaceous earth, natural rubber, polyisoprene, vinyl acetate polymer, polychloroprene, acrylonitrile butadiene polymer, hydrogenated acrylonitrile butadiene polymer, EPDM polymer, ethylene propylene polymer, styrene butadiene polymer, styrene/propylene/diene polymer, brominated poly(isobutylene-co-4-methylstyrene), butyl polymer, chlorosulfonated polyethylenes, polyacrylate, polyurethane, silicone polymer, brominated butyl rubber, chlorinated butyl rubber, chlorinated polyethylene, epichlorohydrin ethylene oxide copolymer, ethylene acrylate polymer, sulfonated polyethylene, fluoro silicone rubbers, fluoroelastomers, substituted styrene acrylate copolymers and bivalent cationic compounds. Any copolymer or multipolymers described above may be a block or non-block (e.g. random) polymer.

Geopolymer Systems with Improved Tensile Strength

Geopolymer systems with improved tensile strength can be made using geopolymer precursors that comprise an aluminosilicate source, a metal silicate, an additive for improving tensile strength, an alkali or alkaline earth hydroxide source and a carrier fluid. The additive for improving tensile strength comprises a strong fibrous material. The strong fibrous material may be a natural fiber, which can be animal fiber such as wool, plant fiber such as cotton, jute, or wood; or inorganic fibers such as mineral fiber, for example Wolasstonite, semi-synthetic fiber, for example rayon, artificial silk, Modal, Lycocell, or other modified natural fibers, regenerated fiber, for example cellulose acetate, a polymer fiber, for example polyolefin, polyester, polylactic acid, and polyamide, or glass fiber, for example borosilicate glass fiber or another silica based material potentially containing oxides of calcium, boron, sodium, aluminum, and/or iron, metal fiber, and carbon fiber; or a combination thereof. In this context, “inorganic” is used to refer to sources that are not entirely biological or organic.

The fibers of the strong fibrous material may be crimped or uncrimped, for example straight, and may have a length between 1 mm and 50 mm, or between 5 mm and 20 mm, or between 10 mm and 20 mm, or between 10 mm and 14 mm. The fibers may have a diameter between 1 μm and 2000 μm, or between 1 μm and 500 μm, or between 5 μm and 200 μm, or between 1 μm and 50 μm, or about 20 μm. The fibers may be present in the geopolymer composition at a concentration between 1% and 20% by weight of solids, or between 5% and 15% by weight of solids.

The glass fibers may be provided in the form of a slurry. The carrier fluid in the slurry may be a hydrocarbon oil, an aqueous fluid or a glycol.

### EXAMPLES

The following examples present the results of laboratory tests that demonstrate the effects of various additives on the expansion, mechanical and self-healing properties of geopolymer systems. The laboratory procedures followed standard methods published by the American Petroleum Institute in Publication RP-10B.

### Example 1—Mechanical Properties

Two types of polymeric particles were evaluated: a polypropylene copolymer (PPC) and a blend of polyisoprene, styrene-butadiene and carbon black (PSC). The compositions of the geopolymer precursors are given in Table 1.

TABLE 1
Compositions of geopolymer precursors containing flexibility agents.

| | Test No. | | | | | | |
|---|---|---|---|---|---|---|---|
| | 1 | 2 | | 3 | | 4 | |
| | Fluid ID | | | | | | |
| | | PPC | | PSC | | PSC | |
| | Baseline | 20% BVOB | | 20% BVOB | | 10% BVOB | |
| Formulation | Grams | Grams | BVOB % | Grams | BVOB % | Grams | BVOB % |
| Type F Fly Ash | 624 | 409.6 | 50.0 | 395.2 | 50.0 | 426.2 | 60.0 |
| Silica (<5 μm) | | 74.6 | 10.0 | 72.0 | 10.0 | 64.7 | 10.0 |
| Silica (100 μm) | | 149.2 | 20.0 | 144.0 | 20.0 | 129.4 | 20.0 |
| PPC | | 50.7 | 20.0 | — | — | — | — |
| Polyisoprene | | — | | 63.6 | 20.0 | 28.6 | 10.0 |
| and carbon | | | | | | | |
| black (PSC) | | | | | | | |
| | | | gal/sk | | gal/sk | | gal/sk |
| 50% NaOH | 134 | 138.5 | 1.6 | 136.6 | 1.6 | 131.3 | 1.6 |
| Na Silicate | 79 | 80.5 | 1.0 | 79.4 | 1.0 | 76.3 | 1.0 |
| Sea Water | 161 | 173.4 | | 185.7 | | 219.8 | |
| Polyglycol | 1 | 1.1 | 0.02 | 1.1 | 0.02 | 1.1 | 0.02 |
| Antifoam | | | | | | | |
| Styrene | 89 | — | | — | | — | |
| Butadiene | | | | | | | |
| Latex | | | | | | | |
| Polyanionic | 1.39 | 1.0 | 0.14 | 1.0 | 0.16 | 1.0 | 0.16 |
| Cellulose | | | | | | | |
| SVF (%) | 40.6 | 47.0 | | 45.4 | | 40.8 | |
| Density, ppg | 15.0 | 15.0 | | 15.0 | | 15.0 | |

BVOB = by volume of solid blend;
gal/sk = gallons per 100-lb sack of solid blend;
SVF = solids volume fraction

The precursors were cured at a temperature of 140° F. (60 °C) and a pressure of 2000 psi (14 MPa) for up to 7 days. Unconfined compressive strength, tensile strength, Young's modulus and Poisson's ratio of the resulting geopolymers were measured. The results are shown in Table 2.

TABLE 2
Mechanical properties of geopolymers containing flexibility agents.

| | | | Loading | |
|---|---|---|---|---|
| | | | Static | Loading |
| | Unconfined | Tensile | Young's | Static |
| Test | Compressive | Strength | Modulus | Poisson's |
| No. | Strength (psi) | (psi) | (psi) | Ratio |
| 1 | 2583 | 154 | 787,050 | 0.24 |
| 2 | 1456 | 152 | 308,063 | 0.21 |
| 3 | 692 | 113 | 78,179 | 0.32 |
| 4 | 1079 | 123 | 327,126 | 0.14 |

The results show that, compared to the control formulation containing no flexibility agent (Test No. 1), the Young's moduli of the geopolymer systems containing a flexibility agent were substantially lower.

### Example 2—Tensile Strength

Various fibers were evaluated as an additive for increasing the tensile strength of geopolymer systems. Alkali-resistant glass fibers were employed in experiments detailed below. The glass fiber length was between 10 mm and 14 mm, and the fiber diameter was 20 μm. Experiments were also performed using polyester fibers and jute natural fibers.

The base geopolymer precursor without fibers, and the resulting geopolymer, is Test No. 5. Glass fibers were added to this precursor at a concentration of 2.5 lbm/bbl for Test No. 6. Polyester fibers were added to the precursor of Test No. 5 at the same concentration for Test No. 7. Jute natural fibers were added to the precursor of Test No. 5 at the same concentration for Test No. 8. The results are shown in Table 3.

TABLE 3
Effect of various fibers on tensile strength of geopolymer system.
(lbm/bbl = pounds/US barrel. One barrel = 42 gal)

| Test No. | 5 | 6 | 7 | 8 |
|---|---|---|---|---|
| Formulation | grams | grams | grams | Grams |
| Type F Fly Ash | 589 | 589 | 589 | 589 |
| 50% NaOH | 170 | 170 | 170 | 170 |
| Sodium Silicate | 98 | 98 | 98 | 98 |
| Sea Water | 132 | 132 | 132 | 132 |
| Polyglycol | 1 | 1 | 1 | 1 |
| Antifoam | | | | |
| Styrene Butadiene | 89 | 89 | 89 | 89 |
| Latex | | | | |
| Polyanionic | 1.47 | 1.47 | 1.47 | 1.47 |
| Cellulose | | | | |
| Glass Fibers | | 2.5 lbm/bbl | | |
| Polyester Fibers | | | 2.5 lbm/bbl | |
| Jute Natural Fibers | | | | 2.5 lbm/bbl |
| SVF % | 40.6 | 40.6 | | |
| Density, lbm/gal | 15.0 | 15.0 | | |
| Temperature, °F | 140 | 140 | | |
| Pressure, psi | 2000 | 2000 | | |
| Mechanical | | | | |
| Properties | | | | |
| 24-hr Unconfined | 880 | — | — | — |
| Compressive | | | | |
| Strength, psi | | | | |
| 4-day Tensile | 142 | — | 186 | 260 |
| Strength, psi | | | | |
| 7-day Tensile | 272 | 319 | — | — |
| Strength, psi | | | | |
| 14-day Tensile | 261 | 324 | — | — |
| Strength, psi | | | | |

The results show that the presence of various fibers in the geopolymer substantially increased the tensile strength of the geopolymer.

### Example 3—Self-Healing

Two geopolymer systems were evaluated for their self-healing ability. One formulation was tested in the presence of a hydrocarbon oil (Escaid 110, available from ExxonMobil). The other formulation was tested in the presence of a commercial carbonated water having a pH of 4.8 to mimic the presence of CO₂. Both geopolymers employed the same precursor composition described in Test No. 5 above.

Test Nos. 9 and 10 are geopolymer formulations designed to self-heal in hydrocarbon oil. The self-healing additive for Test No. 9 was a blend of styrene-butadiene copolymer, polyisoprene and carbon black (PSC), and was present in the geopolymer precursor at a concentration of 10% BVOB. The self-healing additive for Test No. 10 was styrene/isoprene copolymer and was also present in the geopolymer precursor at a concentration of 10% BVOB. Table 4 presents the precursor compositions in comparison to the precursor composition of Test No. 5.

TABLE 4
Geopolymer precursor formulations for self-healing in hydrocarbon oil.

| Test No | 5 | 9 | | | 10 | | |
|---|---|---|---|---|---|---|---|
| SVF, % | 40.6 | 45.3 | | | 41.28 | | |
| Density, lb/gal | 15.0 | 15.0 | | | 15 | | |
| Temperature, °F | 140 | 140 | | | 140 | | |
| Pressure, psi | 2000 | 2000 | | | 2000 | | |
| Formulation | grams | grams | BVOB/gpsc | | grams | BVOB/gpsc | |
| Type F Fly Ash | 589 | 426.2 | 50.0 | | 431.0 | 50.0 | |
| Silica (<5 μm) | | 64.7 | 10.0 | | 65.4 | 10.0 | |
| Silica (100 μm) | | 129.4 | 20.0 | | 130.8 | 20.0 | |
| PSC | | 28.6 | 10.0 | | | | |
| Styrene/isoprene | | | | | 24.0 | 10.0 | |
| copolymer | | | | | | | |
| 50% NaOH | 170 | 131.3 | 1.5 | gal/sk | 131.3 | 1.5 | gal/sk |
| Sodium Silicate, | 98 | 76.3 | 0.95 | gal/sk | 76.3 | 0.95 | gal/sk |
| g | | | | | | | |
| Sea Water, g | 132 | 219.8 | | | 216.4 | | |
| Polyglycol | 1 | 1.1 | 0.02 | gal/sk | 1.1 | 0.02 | gal/sk |
| Antifoam | | | | | | | |
| Styrene | 89 | — | | | — | | |
| Butadiene Latex | | | | | | | |
| Polyanionic | 1.47 | 1.0 | 0.2 | BWOC | 1.0 | 0.2 | BWOC |

Cellulose

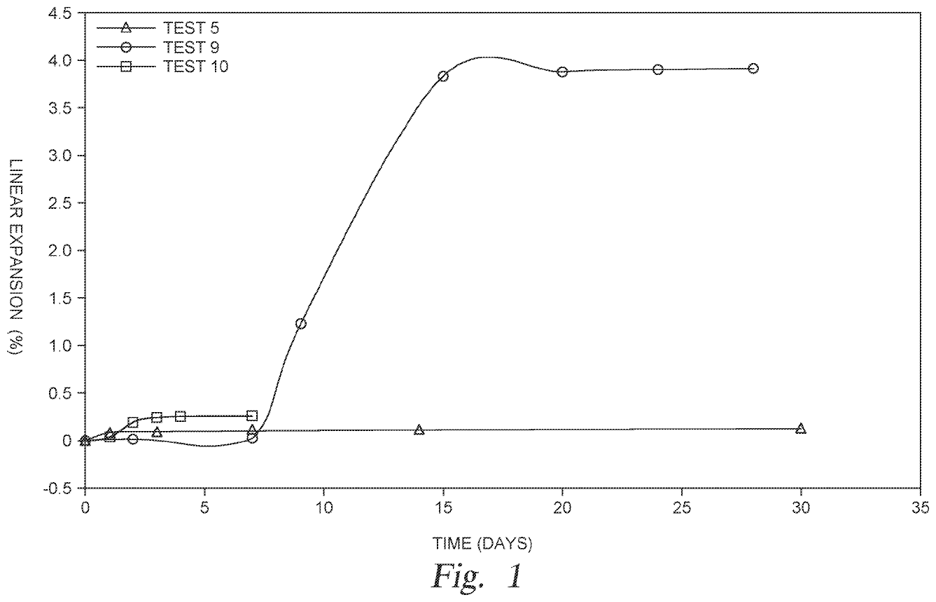

The results are presented In FIG. 1. The linear expansion behavior of the geopolymer of Test No. 9 and Test No. 10 indicates self-healing ability.

Test No. 11 is a geopolymer precursor that gives a geopolymer designed to self-heal in the presence of carbon dioxide. The self-healing additive was a blend of acrylonitrile/butadiene copolymer and calcium carbonate (ABC). The additive was present in the precursor at a concentration of 10% BVOB. Table 5 presents details of the geopolymer precursor composition in comparison to Test No. 5.

TABLE 5
Geopolymer precursors for self-healing in carbon dioxide.

| Test No | 5 | 11 |
|---|---|---|
| SVF, % | 40.6 | 50.03 |
| Density, lbm/gal | 15.0 | 15.0 |
| Temperature, °F | 140 | 140 |
| Pressure, psi | 2000 | 2000 |
| Time to BHP, min | 30 | 30 |
| Formulation | grams | grams |
| Type F Fly Ash | 589 | 589.84 |
| ABC | — | 100.27 |
| 50% NaOH | 170 | 167.63 |
| Sodium Silicate | 98 | 94.02 |
| Sea Water | 132 | 36.41 |
| Polyglycol Antifoam | 1 | 1.16 |
| Styrene Butadiene Latex | 89 | 87.49 |
| Polyanionic Cellulose | 1.47 | 1.61 |

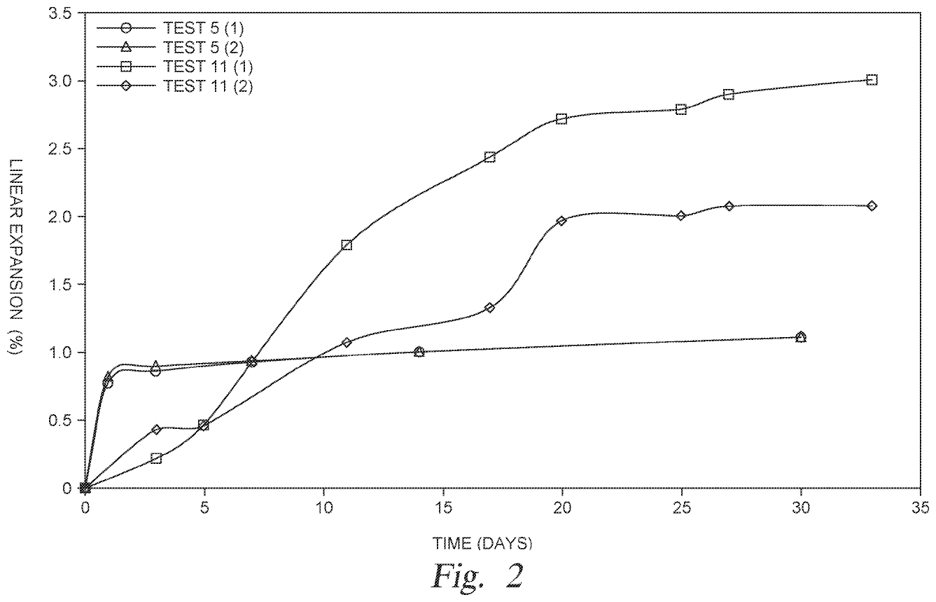

The results are presented in FIG. 2. In FIG. 2, each geopolymer was tested twice. The two test results for Test No. 5 are nearly indistinguishable while the two results for Test No. 11 show more variation, but the linear expansion behavior of the geopolymer of Test No. 11 exhibited in both tests indicates self-healing ability.

### Example 4—Expansion/Shear Bond

A blend of calcined calcium oxide and calcined magnesium oxide was tested as an expanding agent in a geopolymer base. The geopolymer base is Test No. 12. Test Nos. 13-15 are geopolymer precursors having expanding agents. The expanding agent was introduced to the geopolymer base as a powder or as a slurry in a hydrocarbon oil. The expanding agent concentration in the geopolymer precursor was 5% by weight of fly ash. The precursor compositions are presented in Table 6.

TABLE 6
Geopolymer precursors for expansion testing.

| Test No | 12 | 13 | 14 | 15 |
|---|---|---|---|---|
| SVF % | 33.85 | 34.84 | 36.61 | 34.84 |
| Density, ppg | 15.0 | 15.0 | 15.0 | 15.0 |
| Temperature, °F | 140 | 140 | 140 | 140 |
| Pressure, psi | 2000 | 2000 | 2000 | 2000 |
| Time to BHP, min | 30 | 30 | 30 | 30 |
| Formulation | grams | grams | grams | grams |
| Type F Fly Ash | 589 | 589 | 589 | — |
| Alternate Type F Fly | — | — | — | 589 |
| Ash | | | | |
| 50% NaOH | 170 | 170 | 170 | 170 |
| Sodium Silicate | 98 | 98 | 98 | 98 |
| Sea Water | 132 | 132 | 102 | 102 |
| Polyglycol Antifoam | 1 | 1 | 1 | 1 |
| Styrene Butadiene | 89 | 89 | 89 | 89 |
| Latex | | | | |
| Polyanionic Cellulose | 1.47 | 1.47 | 1.47 | 1.47 |
| CaO/MgO (powder) | — | 29.45 | — | 29.45 |
| CaO/MgO (slurry) | — | — | 58.9 | — |

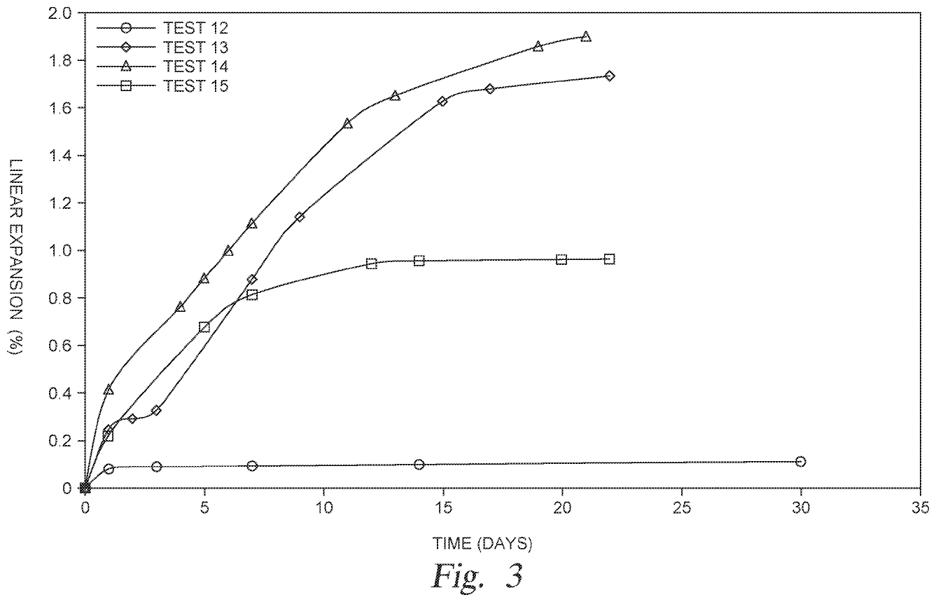

The results are presented in FIG. 3. The linear expansion behavior of the geopolymers of Tests 13-15 show that the CaO/MgO blend is an effective expanding agent in a geopolymer system. The alternate Type F fly ash was sourced from Germany, and the amount of expansion was significantly lower than that achieved with the other Type F fly ash. Fly ashes from different sources therefore may have different reactivities, leading to different results.

Shear bond testing was conducted using the geopolymer precursor of Test No. 13 containing the CaO/MgO expanding agent in powder form. The control precursor was the geopolymer precursor of Test No. 5 described above. The geopolymer precursors were cast into steel cylindrical molds with a diameter of 1.95 in. and a height of 1.97 in. After curing, a hydraulic press was used to push the geopolymer out of the molds and the forces required to expel the geopolymer were divided by the interior surface area of the molds. The results are presented in Table 7.

TABLE 7
Shear-bond strength results.

| Test No. | 5 | 13 |
|---|---|---|
| 14-day shear bond strength, psi | 270 | 397 |

The results demonstrate a significant shear-bond strength improvement when the CaO/MgO expanding agent is present in the geopolymer precursor.

The various additives described herein to impart improved tensile strength, flexibility, expansion, and self-healing to a geopolymer can be used in any combination. Additives to provide improved tensile strength described herein can be combined with one or more additives to additionally provide flexibility, expansion, and/or self-healing. Additives to provide flexibility can be combined with one or more additives to additionally provide improved tensile strength, expansion, and/or self-healing. Additives to provide expansion can be combined with one or more additives to additionally provide flexibility, improved tensile-strength, and/or self-healing. Additives to provide self-healing can be combined with one or more additives to additionally provide flexibility, improved tensile-strength, and/or expansion. The various additives described above to impart such properties are mutually substantially inert, and while the effects imparted by the additives may interact somewhat (for example the flexibility imparted by flexibility additives may be modified by inclusion of tensile strength improvement fibers), those effects do not interact to the extent that one effect cancels another because the mechanisms of the effects are essentially independent. Thus, a geopolymer precursor slurry can include one or more expansion additives, one or more flexibility additives, one or more self-healing additives, and/or one or more tensile strength improvement additives, alone or in any combination.

For example, a strong fibrous material can be added to a geopolymer formulation along with a polymer to impart flexibility and/or a polymer to impart self-healing. These materials will not engage in any substantial mutual chemical reactions, so the flexibility and/or self-healing actions of the polymers will not be affected by the presence of the fibers. While presence of the fibers may reduce the flexibility imparted by the polymers, more polymer can be added, up to a point, to reach a flexibility target in the presence of tensile strength improving fibers. Additionally, improved tensile strength combined with reduced Young's modulus tends to reduce the incidence of structural failures in a geopolymer, as described above, so improving tensile strength by including fibers can reduce the need for more flexibility to reach a target performance. Likewise, the presence of fibers would not substantially affect expansion afforded by any of the expansion reagents described above.

The same is true of the polymers used for flexibility and self-healing in combination with each other and with expansion agents. These polymers will not engage in mutual chemical reactions and will not react with the expansion agents described above, so the flexibility and self-healing effects of the polymers will not interact and will not interact with the expansion effect of the expansion agents.

In some embodiments, a geopolymer precursor comprises at least two additives selected from the group consisting of a self-healing agent, a flexibility agent, an expanding agent, and a tensile strength improving agent. Such agents are described above. The at least two additives are generally present in a geopolymer precursor at concentrations of 1% to 75%, or 5% to 50%, or 1% to 30%, or 2% to 12% by weight of solids in the geopolymer precursor, depending on the mix of additives used.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method, comprising:
forming a geopolymer precursor comprising an aluminosilicate source, a metal silicate, a dispersed expanding agent, an alkali activator and a carrier fluid;
placing the geopolymer precursor into a subterranean well; and
causing the geopolymer precursor to harden and set within the subterranean well to form a geopolymer.

2. (canceled)

3. A method, comprising:
forming a pumpable geopolymer base comprising an aluminosilicate source, a metal silicate, and an alkali activator and a carrier fluid;
dispersing an expanding agent within the geopolymer base to form a geopolymer precursor;
placing the geopolymer precursor into a subterranean well; and
causing the geopolymer precursor to harden and set within the subterranean well to form a geopolymer.

4. (canceled)

5. The method of of claim 1, wherein the expanding agent comprises calcium oxide, magnesium oxide, calcium sulphoaluminate, gypsum, finely ground aluminum powder, or a combination thereof.

6. The method of claim 1, wherein the expanding agent is active after the geopolymer precursor has set.

7. The method of claim 1, wherein the expanding agent comprises particles having an average particle size between 0.1 μm and 900 μm.

8. The method of claim 7, wherein the expanding agent particles are calcined at a temperature between 100 °C and 2000 °C for a period between 1 minute and 24 hours.

9. The method of claim 1, wherein forming the geopolymer precursor comprises adding the expanding agent as a slurry comprising a hydrocarbon oil, glycol fluid, or both.

10. The method of claim 1wherein the geopolymer has a linear expansion that has a magnitude between 0.1% and 5.0%.

11. The method of claim 1, wherein the expanding agent is present in the geopolymer precursor at a concentration between 1% and 30% by weight of solids in the geopolymer precursor.

12. The method of claim 1, wherein, during the linear expansion, imperfections within the geopolymer are healed, and shear bond strength between the geopolymer and tubular and formation surfaces is improved.

13. The method of claim 1, wherein the expanding agent is present in the geopolymer precursor at a concentration between 2% and 10% by weight of solids in the geopolymer precursor.

14. The method of claim 1, wherein the geopolymer precursor also comprises one or more of a self-healing agent, a flexibility agent, or a tensile strength improvement agent.

15. A geopolymer precursor comprising an aluminosilicate source; an alkali activator, a carrier fluid, a dispersed expanding agent, and an additive selected from the group consisting of a self-healing agent, a flexibility agent, a tensile strength improvement agent, and a combination thereof.

16. The geopolymer precursor of claim 15, wherein the expanding agent comprises particles having a size between about 0.1 μm and about 900 μm.

17. The geopolymer precursor of claim 15, wherein the expanding agent comprises particles that are calcined at a temperature between 100 °C and 2000 °C for a period between 1 minute and 24 hours.

18. The geopolymer precursor of claim 15, wherein the expanding agent comprises calcium oxide, magnesium oxide, calcium sulphoaluminate, gypsum, finely ground aluminum powder, or a combination thereof.

19. The geopolymer precursor of claim 15, wherein expanding agent and the additive are present together in the geopolymer precursor at a concentration between about 1% and 75% by weight of solids.

20. The geopolymer precursor of claim 15, wherein the carrier fluid comprises a hydrocarbon oil, a glycol fluid, or both.

20. (canceled)
